(19) United States
(12) Patent Application Publication
(10) Pub. No.: US 2013/0055812 A1
(43) Pub. Date: Mar. 7, 2013

(54) DEVICE FOR DETECTING DOUBLE MOTION AND METHOD OF DETECTING DOUBLE MOTION

(71) Applicants: Byoung Won HWANG, Gyeonggi-do (KR); Kyung Rin KIM, Gyeonggi-do (KR); Chang Hyun KIM, Gyeonggi-do (KR)

(72) Inventors: Byoung Won HWANG, Gyeonggi-do (KR); Kyung Rin KIM, Gyeonggi-do (KR); Chang Hyun KIM, Gyeonggi-do (KR)

(73) Assignee: Samsung Electro-Mechanics CO., LTD.

(21) Appl. No.: 13/589,522

(22) Filed: Aug. 20, 2012

(30) Foreign Application Priority Data
Sep. 6, 2011 (KR) 10-2011-0090169

(51) Int. Cl. G01P 15/18

(52) U.S. Cl. 73/510

(57) ABSTRACT

Provided is a device for detecting a double motion and a method of detecting a double motion. The device includes a sensor configured to detect a motion; a variation rate calculating part configured to calculate a variation rate of a signal output from the sensor; a detecting section control part configured to control a detecting section in reverse proportion to a value; a first motion detecting part and a second motion detecting part configured to determine that a motion occurs; and an output part configured to output a double motion result when a time between a time (t1) and a time (t2), and to output a single motion result when the time between the time (t1) and the time (t2) is larger than the detecting section. Therefore, it is possible to adjust the detecting section to the double motion according to the motion velocity.

### CROSS-REFERENCE TO RELATED APPLICATIONS

This application claims the benefit of Korean Patent Application No. 10-2011-0090169filed with the Korea Intellectual Property Office on Sep. 6, 2011, the disclosure of which is incorporated herein by reference.

### BACKGROUND OF THE INVENTION

1.Field of the Invention

The present invention relates to a device for detecting a double motion and a method of detecting a double motion, and more particularly, to a device for detecting a double motion and a method of detecting a double motion capable of controlling a double motion detecting time according to a velocity of an object to be detected.

2.Description of the Related Art

Various sensors configured to electrically or magnetically detect a motion of a human or an object to output it into an analog signal and/or a digital signal have been developed.

Such sensors apply various means and theories such as an acceleration sensor, an angular velocity sensor, a gyro sensor, a terrestrial magnetism sensor, an optical sensor, and so on.

Here, since the acceleration sensor, the angular velocity sensor, the gyro sensor, and so on, are sensors configured to measure a physical force of inertia, which may be referred to as an inertia sensor. In recent times, techniques of simultaneously measuring acceleration and angular velocity using the sensors to apply them to various applications have been continuously developed.

Output values obtained from the sensors may be converted into analog or digital values, and the output values may be reflected to various applications to be used.

Patent Document 1 discloses a technique of an input device, in which, when a hand-shaking is input into the input device, an output signal thereof is corrected to make a user cannot feel a phase delay.

Patent Document 2 discloses a technique capable of recognizing a double tap and a single tap using an inertia sensor.

Meanwhile, a double tap performing velocity or a tap-to-tap interval may be various according to a user. However, conventional double tap recognition techniques including Patent Documents 1 and 2 have a double tap recognition section, which is fixed to a certain value.

Accordingly, in the conventional art, when the double tap is rapidly performed or slowly performed according to a user's habits or circumstances, which is different from a fixed double tap recognition section. For this reason, the double tap motion may not be recognized, or output of a double tap recognition signal may be unnecessarily delayed.

### RELATED ART DOCUMENTS

### Patent Documents

Patent Document 1: Korean Patent Laid-open Publication No.: 2010-068335

Patent Document 2: Korean Patent Laid-open Publication No.: 2010-256947

### SUMMARY OF THE INVENTION

The present invention has been invented in order to overcome the above-described problems and it is, therefore, an object of the present invention to provide a device for detecting a double motion and a method of detecting a double motion capable of adjusting a detection section in which a double motion is detected according to a motion velocity.

In accordance with one aspect of the present invention to achieve the object, there is provided a device for detecting a double motion including: a sensor configured to detect a motion; a variation rate calculating part configured to calculate a variation rate of a signal output from the sensor; a detecting section control part configured to control a detecting section in reverse proportion to a value calculated by the variation rate calculating part; a first motion detecting part and a second motion detecting part configured to determine that a motion occurs when the signal output from the sensor exceeds a predetermined threshold; and an output part configured to output a double motion result when a time between a time (t1) that the first motion detecting part determines occurrence of a motion and a time (t2) that the second motion detecting part determines occurrence of a motion is smaller than the detecting section, and to output a single motion result when the time between the time (t1) and the time (t2) is larger than the detecting section.

Here, the variation rate calculating part may include a difference value calculating part configured to calculate a difference value (Diff) of the signals output from the sensor; and an accumulated average calculating part configured to calculate an accumulated average value of the difference values calculated by the difference value calculating part.

In addition, the difference value calculating part may calculate an n+1th difference value (Diffₙ₊₁) according to the following equation 1:

Diffₙ₊₁=dₙ₊₁−dₙ [Equation 1]

here, n is an integer, not negative.

Further, the accumulated average calculating part may calculate the difference value calculated by the difference value calculating part according to the following equation 2:

$$( {\sum }_{n = 0}^{N - 1} {Diff}_{n + 1} ) / N \qquad [ Equation 2 ]$$

here, N is an integer, not negative.

Meanwhile, the variation rate calculating part may include a difference value calculating part configured to calculate the difference value (Diff) of the signals output from the sensor; and a maximum value selecting part configured to select a maximum value of the difference values calculated by the difference value calculating part.

Here, the difference value calculating part may calculate an n+1th difference value (Diffₙ₊₁) according to the following equation 1:

Diffₙ₊₁=dₙ₊₁−dₙ [Equation 1]

here, n is an integer, not negative.

Meanwhile, the variation rate calculating part may include a slope calculating part configured to calculate a slope of the signals output from the sensor; and a maximum slope deducing part configured to deduce a maximum value of the slope calculated by the slope calculating part.

Here, the slope calculating part may calculate a slope (L(t)) at a certain time (t) according to the following equation 3:

$$L ( t ) = \frac{d }{d t} S ( t ) . \qquad [ Equation 3 ]$$

Meanwhile, the variation rate calculating part may include an integration calculating part configured to integrate a size of the signals output from the sensor with respect to a time.

In accordance with another aspect of the present invention to achieve the object, there is provided a method of detecting a double motion including: (A) detecting a motion to output a signal according to a motion; (B) determining whether the signal output in the step (A) exceeds a predetermined threshold to detect a first motion; (C) calculating a variation rate of the signal output in the step (A); (D) controlling a detecting section in proportion to the value calculated in the step (B); and (E) determining whether the signal output in the step (A) from a time when the first motion is detected from the signal output in the step (A) to a time corresponding to the detecting section exceeds a predetermined threshold and detecting a second motion.

Here, the step (B) may include calculating a difference value (Diff) of the signals output in the step (A); and calculating an accumulated average value of the calculated difference values.

In addition, in calculating the difference value (Diff), an n+1th difference value (Diffₙ₊₁) may be calculated according to the following equation 1:

Diffₙ₊₁=dₙ₊₁−dₙ [Equation 1]

here, n is an integer, not negative.

Further, in calculating the accumulated average value, the difference value calculated in calculating the difference value may be calculated according to the following equation 2:

$$( {\sum }_{n = 0}^{N - 1} {Diff}_{n + 1} ) / N \qquad [ Equation 2 ]$$

here, N is an integer, not negative.

Meanwhile, the step (B) may include calculating the difference value (Diff) of the signals output in the step (A); and selecting a maximum value of the calculated difference values.

Here, in calculating the difference value (Diff), an n+1th difference value (Diffₙ₊₁) may be calculated according to the following equation 1:

Diffₙ₊₁=dₙ₊₁−dₙ [Equation 1]

here, n is an integer, not negative.

Meanwhile, the step (B) may include calculating a slope of the signals output in the step (B); and deducing a maximum of the calculated slopes.

Here, calculating the slope, the slope (L(t)) at a certain time (t) may be calculated according to the following equation 3:

$$L ( t ) = \frac{d }{d t} S ( t ) . \qquad [ Equation 3 ]$$

Meanwhile, in the step (B), a size of the signals output in the step (A) may b e integrated with respect to a time.

In accordance with another aspect of the present invention to achieve the object, there is provided a method of detecting a double motion using a sensor configured to detect a motion and output a single according to the motion, which includes: outputting the signal from the sensor in which the motion is detected; detecting a first motion by determining whether the signal output from the sensor exceeds a predetermined threshold, and calculating a velocity of the motion from the signal output from the sensor; adjusting a detecting section in reverse proportion to the velocity of the motion; and outputting a double motion result when the signal output from the sensor exceeds the predetermined threshold again until the detecting section elapses.

Here, a single motion result may be output when the signal output from the sensor does not exceed the predetermined threshold again until the detecting section elapses.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are views showing a relationship between a signal output from a sensor and a detecting section;

FIG. 2 is a block diagram schematically showing a device for detecting a double motion in accordance with an exemplary embodiment of the present invention;

FIG. 3 is a block diagram schematically showing a control unit in accordance with an exemplary embodiment of the present invention;

FIG. 4 is a view for explaining a variation ratio calculating process in accordance with an exemplary embodiment of the present invention;

FIG. 5 is a view for explaining a variation ratio calculating process in accordance with an exemplary embodiment of the present invention;

FIG. 6 is a flowchart schematically showing a method of detecting a double motion in accordance with an exemplary embodiment of the present invention.

### DETAILED DESCRIPTION OF THE PREFERABLE EMBODIMENTS

The following embodiments are provided as examples to fully convey the spirit of the invention to those skilled in the art. Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

Terms used herein are provided for explaining embodiments of the present invention, not limiting the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, motions, and/or devices, but do not preclude the presence or addition of one or more other components, motions, and/or devices thereof.

Hereinafter, configuration and operation effects of the present invention will be described in detail with reference to the accompanying drawings.

FIGS. 1A and 1B are views showing a relationship between a signal output from a sensor 1 and a detecting section.

Referring to FIGS. 1A and 1B, in the case of FIG. 1A, a first motion and a second motion occur in a detecting section Tw, and in the case of FIG. 1B, only the first motion occurs in the detecting section Tw and the second motion occurs outside the detecting section Tw.

At this time, when an electrical signal, which is output by detecting a motion using the sensor 1, exceeds a predetermined threshold, it can be detected that there is a motion.

However, a motion velocity of a user or an object to be detected may be different according to circumstances. That is, provided that both of two cases shown in FIGS. 1A and 1B are provided for the double motion, it will be appreciated that the motion velocity of the case shown in FIG. 1B is smaller than that of the case shown in FIG. 1A.

In this case, while a result in the case of FIG. 1A may output that the double motion is detected, a result in the case of FIG. 1B does not output that no double motion is detected, causing malfunction, even though the double motion occurs.

While not shown, a reversed case may be possible.

That is, even when the double motion rapidly occurs, the result that the double motion is detected is not output until the detecting section Tw is terminated. Accordingly, the result output is unnecessarily delayed.

In order to solve the problems, the inventor(s) conceived an apparatus and method capable of optimizing the detecting section in consideration of the motion velocity.

Meanwhile, in the specification, the motion may include various motions such as a tap, a swing, a touch, and so on.

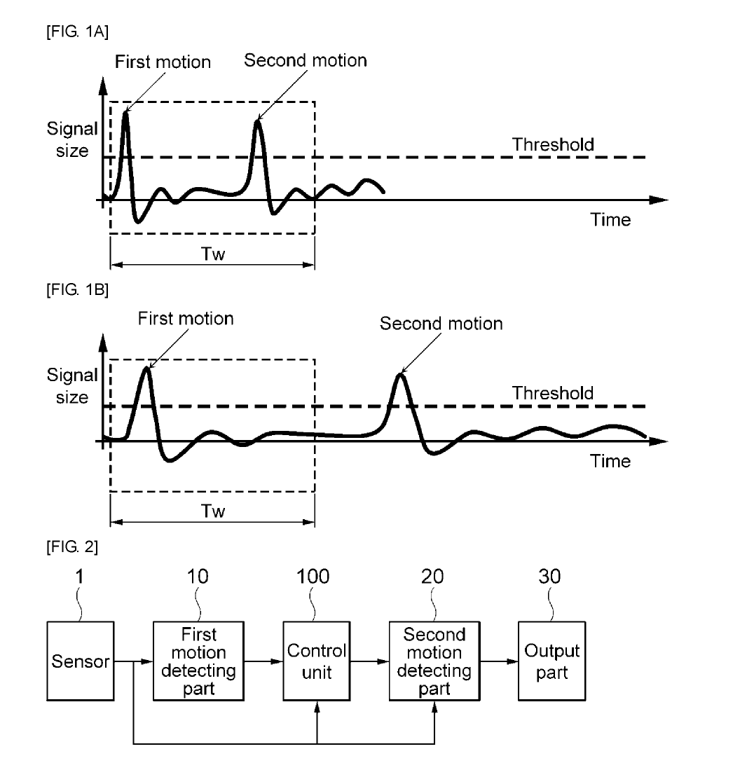

FIG. 2 is a block diagram schematically showing a device for detecting a double motion in accordance with an exemplary embodiment of the present invention.

Referring to FIG. 2, the device for detecting a double motion in accordance with an exemplary embodiment of the present invention may include a sensor 1, a first motion detecting part 10, a second motion detecting part 20, a control unit 100, and an output part 30.

The sensor 1, which performs a function of detecting a motion to output an electrical signal, may be implemented by various kinds of inertial sensors such as an acceleration sensor, an angular velocity sensor, a gyro sensor, and so on.

The first motion detecting part 10 and the second motion detecting part 20 determine whether a signal output from the sensor 1 exceeds the predetermined threshold, to determine whether a motion occurs, detecting a first motion and a second motion, respectively.

Meanwhile, it is determined whether the second motion occurs within a predetermined time from the time when the first motion detecting part 10 detects the first motion. At this time, the predetermined time is defined as a detecting section Tw in this specification.

The output part 30 may output a double motion result or a single motion result according to the signals output from the first motion part 10 and the second motion part 20. Of course, at this time, the single motion result may not be separately output.

The control unit 100 performs a function of reflecting a velocity of the first motion to adjust a length of the detecting section Tw. Here, when the velocity of the first motion is fast, the length of the detecting section Tw is determined to be short, and when the velocity of the first motion is slow, the length of the detecting section Tw is determined to be long, preventing malfunction and maximally reducing a processing time. That is, the velocity of the first motion is in reverse proportion to the length of the detecting section Tw.

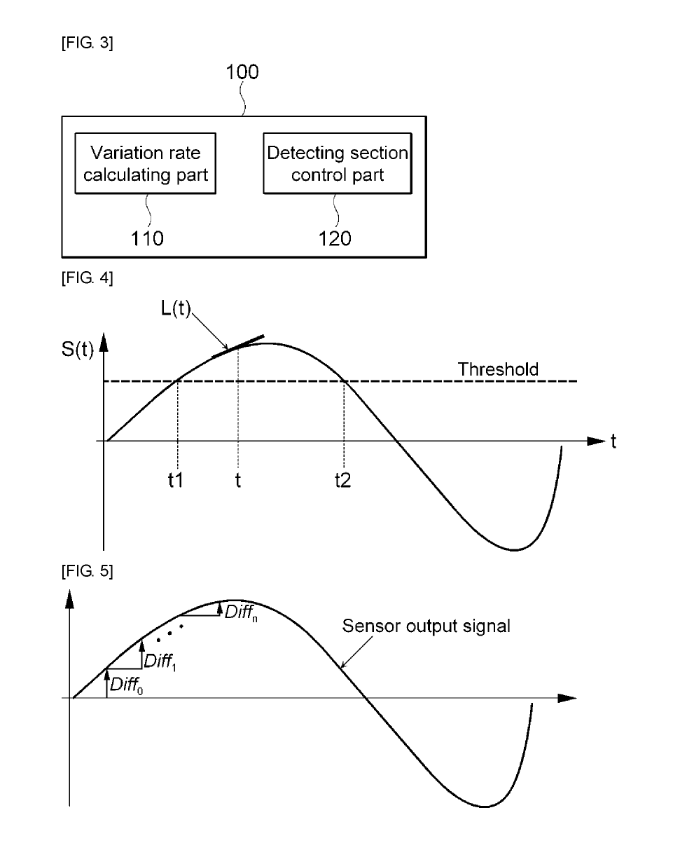

FIG. 3 is a block diagram schematically showing the control unit 100 in accordance with an exemplary embodiment of the present invention.

Referring to FIG. 3, the control unit 100 may be constituted by a variation rate calculating part 110 and a detecting section control part 120.

The variation rate calculating part 110 calculates a variation rate of the signal output from the sensor 1. Here, the variation rate of the signal may represent the velocity of the motion. A specific embodiment and operational principle of the variation rate calculating part 110 will be described below with reference to FIGS. 4 and 5.

The detecting section control part 120 functions to control the detecting section Tw according to a value calculated by the variation rate calculating part 110. Here, the detecting section Tw is controlled through a method in which the detecting section Tw is reduced as the variation rate is increased.

Meanwhile, the detecting section control part 120 may set a time limit to determine whether the second motion detecting part 20 detects occurrence of the second motion. In addition, the detecting section may be initiated from a time that the first motion is detected, i.e., a time that the signal output by detecting the first motion by the sensor 1 exceeds a predetermined threshold.

Accordingly, the cross-sectional view of detecting a double motion in accordance with an exemplary embodiment of the present invention adjusts a double motion detecting time by reflecting a motion velocity of an object to be detected, reducing probability of occurrence of malfunction.

In addition, it is possible to reduce a delay time generated because the output of the detected result value must be on standby during a fixed detecting time even though the double motion is detected.

FIGS. 4 and 5 are views for explaining a variation rate calculating method in accordance with an exemplary embodiment of the present invention.

The variation rate calculating part 110 can calculate a difference value and deduces an accumulated average or a maximum value as a representative value, calculating a variation rate of the signal, i.e., a velocity of the motion.

In addition, the variation rate calculating part 110 may calculate a slope of tangent of a signal waveform output from the sensor, calculating the velocity of the motion.

Further, the variation rate calculating part 110 can integrate a signal value output from the sensor 1 with respect to a time, calculating the velocity of the motion.

Referring to FIG. 4, the variation rate calculating part 110 may include a slope calculating part configured to calculate a slope of signals output from the sensor 1, and a maximum slope deducing part configured to deduce a maximum value of a slope calculated by the slope calculating part.

Here, an instant variation rate at a certain time t, i.e., a slope L(t) of a tangent line formed by the signal output from the sensor 1 at a certain time t may be calculated using the following equation 3. Here, S(t) means a size of the signal output from the sensor 1 at a time t, which may be represented as a kind of function.

$$L ( t ) = \frac{d }{d t} S ( t ) . \qquad [ Equation 3 ]$$

The maximum slope deducing part can perform a function of deducing a maximum value of the slope calculated by the slope calculating part.

While not shown, the variation rate calculating part 110 may include an integration calculating part configured to integrate a size of the signals output from the sensor 1 with respect to a time, determining a variation rate of the signals output from the sensor 1, i.e., a motion velocity. In this case, the integration may be performed using the flowing equation 4.

A=∫ₜ^{t+Δt}S(t)dt [Equation 4]

FIG. 5 is a view for explaining a variation rate calculating process in accordance with an exemplary embodiment of the present invention.

Referring to FIG. 5, the variation rate calculating part 110 may include a difference value calculating part and an accumulated average calculating part.

The difference value calculating part performs a function of calculating a difference value Diff of the signals output from the sensor 1, and the accumulated average calculating part performs a function of calculating an accumulated average value of the difference values calculated by the difference value calculating part.

Here, the difference value calculating part can calculate a difference value of the signals output from the sensor 1 through a method of calculating an n+1th difference value Diffₙ₊₁ using the following equation 1.

Diffₙ₊₁=dₙ₊₁−dₙ [Equation 1]

Here, n is an integer, not negative, such as 0, 1, 2, 3, 4, 5 . . . .

In addition, the accumulated average calculating part may calculate the difference value Diff calculated by the difference value calculating part according to the following equation 2.

$$( {\sum }_{n = 0}^{N - 1} {Diff}_{n + 1} ) / N \qquad [ Equation 2 ]$$

Here, N is an\ predetermined integer, not negative, such as 0, 1, 2, 3, 4, 5 . . . .

For example, provided that n is increased by 1 as a unit of 0.1 second, the signal value output from the sensor 1 during one second is divided into 10 parts, the difference value calculating part calculates a difference value in each section, and the accumulated average calculating part calculates an average value of the 10 difference values.

Meanwhile, N may be differently determined according to precision of the variation rate calculating part 110. That is, in order to increase precision of the variation rate calculating part 110, N is set as a large value with reference to a certain time. When N is set as a small value with reference to the same time, precision of the variation rate calculating part 110 is reduced.

For example, N may be 10 when one second is divided into 10 parts as described in the above example. In this case, the difference vale Diff is calculated by a unit of 0.1 second. When N is set as 100, the difference value Diff is calculated by a unit of 0.01 second.

Accordingly, when precise control of the detecting section Tw is necessary, N is set as a large value, and on the contrary, when precise control of the detecting section Tw is unnecessary, N is set as a small value, enabling control of the optimized detecting section Tw.

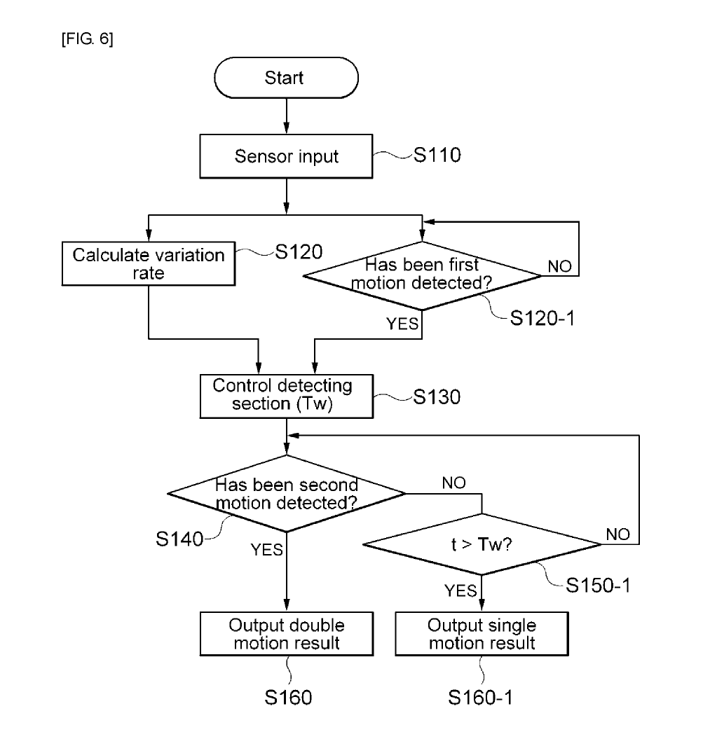

FIG. 6 is a flowchart schematically illustrating a method of detecting a double motion in accordance with an exemplary embodiment of the present invention.

Referring to FIG. 6, first, a sensor 1 detects a motion to output a signal according to the motion (S110).

Next, it is determined whether the signal output from the sensor 1, i.e., the signal input by the sensor 1 exceeds a predetermined threshold to detect a first motion (S120-1).

Meanwhile, a variation rate calculating part 110 calculates a variation rate of the signal input by the sensor 1 separately from detection of the first motion (S120). A variation rate calculating method is the same as above, and thus, overlapping description will be omitted.

Next, a detecting section Tw is controlled in reverse proportion to the calculated value (S130).

Next, a second motion is detected by the signal output from the sensor 1 (S140).

At this time, detection of the second motion may be performed through a method of determining whether the signal output from the first sensor 1 exceeds a predetermined threshold from a time when the first motion is detected to a time corresponding to the detecting section Tw.

Next, when the second motion is detected in the detecting time Tw, a double motion result is output (S160). Here, when the signal output from the sensor 1 does not exceeds a predetermined threshold until the detecting section Tw elapses, a single motion result is output (S160-1).

As can be seen from the foregoing, the device for detecting a double motion and the method of detecting a double motion of the present invention adjust a double motion detecting time by reflecting a motion velocity of an object to be detected, reducing probability of occurrence of malfunction.

In addition, it is possible to reduce a delay time generated because the output of the detected result value must be on standby during a fixed detecting time even though the double motion is detected.

The above-mentioned description illustrates the present invention. In addition, the above description merely represents and describes an exemplary embodiment of the present invention, and the present invention may be used various different combinations, modifications and environments. That is, the present invention may be modified or varied within a range of a concept of the present invention disclosed herein, an equivalent range of disclosure of writing and/or a range of a technique or knowledge in the art. As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A device for detecting a double motion comprising:
a sensor configured to detect a motion;
a variation rate calculating part configured to calculate a variation rate of a signal output from the sensor;
a detecting section control part configured to control a detecting section in reverse proportion to a value calculated by the variation rate calculating part;
a first motion detecting part and a second motion detecting part configured to determine that a motion occurs when the signal output from the sensor exceeds a predetermined threshold; and
an output part configured to output a double motion result when a time between a time (t1) that the first motion detecting part determines occurrence of a motion and a time (t2)that the second motion detecting part determines occurrence of a motion is smaller than the detecting section, and to output a single motion result when the time between the time (t1) and the time (t2) is larger than the detecting section.

2. The device for detecting a double motion according to claim 1, wherein the variation rate calculating part comprises:
a difference value calculating part configured to calculate a difference value (Diff) of the signals output from the sensor; and
an accumulated average calculating part configured to calculate an accumulated average value of the difference values calculated by the difference value calculating part.

3. The device for detecting a double motion according to claim 2, wherein the difference value calculating part calculates an n+1th difference value (Diffₙ₊₁) according to the following equation 1:
Diffₙ₊₁=dₙ₊₁−dₙ [Equation 1]
here, n is an integer, not negative.

4. The device for detecting a double motion according to claim 3, wherein the accumulated average calculating part calculates the difference value calculated by the difference value calculating part according to the following equation 2:
$$( {\sum }_{n = 0}^{N - 1} {Diff}_{n + 1} ) / N \qquad [ Equation 2 ]$$
here, N is an integer, not negative.

5. The device for detecting a double motion according to claim 1, wherein the variation rate calculating part comprises:
a difference value calculating part configured to calculate the difference value (Diff) of the signals output from the sensor; and
a maximum value selecting part configured to select a maximum value of the difference values calculated by the difference value calculating part.

6. The device for detecting a double motion according to claim 5, wherein the difference value calculating part calculates an n+1th difference value (Diffₙ₊₁) according to the following equation 1:
Diffₙ₊₁=dₙ₊₁−dₙ [Equation 1]
here, n is an integer, not negative.

7. The device for detecting a double motion according to claim 1, wherein the variation rate calculating part comprises:
a slope calculating part configured to calculate a slope of the signals output from the sensor; and
a maximum slope deducing part configured to deduce a maximum value of the slope calculated by the slope calculating part.

8. The device for detecting a double motion according to claim 7, wherein the slope calculating part calculates a slope (L(t)) at a certain time (t) according to the following equation 3:
$$L ( t ) = \frac{d }{d t} S ( t ) . \qquad [ Equation 3 ]$$

9. The device for detecting a double motion according to claim 1, wherein the variation rate calculating part comprises:
an integration calculating part configured to integrate a size of the signals output from the sensor with respect to a time.

10. A method of detecting a double motion comprising:
(A) detecting a motion to output a signal according to a motion;
(B) determining whether the signal output in the step (A) exceeds a predetermined threshold to detect a first motion;
(C) calculating a variation rate of the signal output in the step (A);
(D) controlling a detecting section in proportion to the value calculated in the step (B); and
(E) determining whether the signal output in the step (A) from a time when the first motion is detected from the signal output in the step (A) to a time corresponding to the detecting section exceeds a predetermined threshold and detecting a second motion.

11. The method of detecting a double motion according to claim 10, wherein the step (B) comprises:
calculating a difference value (Diff) of the signals output in the step (A); and
calculating an accumulated average value of the calculated difference values.

12. The method of detecting a double motion according to claim 11, wherein, in calculating the difference value (Diff), an n+1th difference value (Diffₙ₊₁) is calculated according to the following equation 1:
Diffₙ₊₁=dₙ₊₁−dₙ [Equation 1]
here, n is an integer, not negative.

13. The method of detecting a double motion according to claim 12, wherein, in calculating the accumulated average value, the difference value calculated in calculating the difference value is calculated according to the following equation 2:
$$( {\sum }_{n = 0}^{N - 1} {Diff}_{n + 1} ) / N \qquad [ Equation 2 ]$$
here, N is an integer, not negative.

14. The method of detecting a double motion according to claim 10, wherein the step (B) comprises:
calculating the difference value (Diff) of the signals output in the step (A); and
selecting a maximum value of the calculated difference values.

15. The method of detecting a double motion according to claim 14, wherein, in calculating the difference value (Diff), an n+1th difference value (Diffₙ₊₁) is calculated according to the following equation 1:
Diffₙ₊₁=dₙ₊₁−dₙ [Equation 1]
here, n is an integer, not negative.

16. The method of detecting a double motion according to claim 10, wherein the step (B) comprises:
calculating a slope of the signals output in the step (B); and
deducing a maximum of the calculated slopes.

17. The method of detecting a double motion according to claim 16, wherein, calculating the slope, the slope (L(t)) at a certain time (t) is calculated according to the following equation 3:
$$L ( t ) = \frac{d }{d t} S ( t ) . \qquad [ Equation 3 ]$$

18. The method of detecting a double motion according to claim 16, wherein, in the step (B), a size of the signals output in the step (A) is integrated with respect to a time.

19. A method of detecting a double motion using a sensor configured to detect a motion and output a single according to the motion, which comprises:
outputting the signal from the sensor in which the motion is detected;
detecting a first motion by determining whether the signal output from the sensor exceeds a predetermined threshold, and calculating a velocity of the motion from the signal output from the sensor;
adjusting a detecting section in reverse proportion to the velocity of the motion; and
outputting a double motion result when the signal output from the sensor exceeds the predetermined threshold again until the detecting section elapses.

20. The method of detecting a double motion according to claim 19, wherein a single motion result is output when the signal output from the sensor does not exceed the predetermined threshold again until the detecting section elapses.
